(19) United States
(12) Patent Application Publication
(10) Pub. No.: US 2009/0031231 A1
(43) Pub. Date: Jan. 29, 2009

(54) INFORMATION PROCESSING APPARATUS, INFORMATION PROCESSING METHOD, AND STORAGE MEDIUM

(75) Inventor: Takaya Tsujii, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/175,760

(22) Filed: Jul. 18, 2008

(30) Foreign Application Priority Data
Jul. 24, 2007 (JP) 2007-192265

(51) Int. Cl. G06F 9/46; G06F 3/048

(52) U.S. Cl. 715/764; 718/102

(57) ABSTRACT

When an image processing device specified as the destination of registration of a hot folder by a user is not capable of executing a job flow of the hot folder, another image processing device for achieving the job flow of the hot folder in collaboration with the specified image processing device is searched for. As an alternative to the hot folder, a first hot folder for operating the specified image processing device to execute a first job flow executable by the specified image processing device and a second hot folder for operating another image processing device found in the search to execute a second job flow executable by the found image processing device are created.

### BACKGROUND OF THE INVENTION

1. Field of the Invention

The present invention relates to an information processing apparatus and information processing method for creating a job execution folder for operating a processing device to process data entered into a data box of the processing device in accordance with a job flow and to a storage medium.

2. Description of the Related Art

Some image processing devices (e.g., digital multifunction peripherals and page printers) have a box (storage device) for storing document data received from an information processing apparatus (e.g., a host computer) and image data obtained by a scanner reading an original.

There is a technique for registering a job execution folder for operating an image processing device having such a box to process data entered into the box in accordance with a job flow, in association with the box (see, for example, Japanese Patent Laid-Open No. 2006-253988). The job execution folder is commonly called a hot folder. An image processing device in which a hot folder is registered in association with a box processes, for example, document data in accordance with a job flow of the hot folder when the document data is entered into the box.

The hot folder can be created by an information processing apparatus (e.g., a personal computer) connected to the image processing device. The created hot folder is registered in the image processing device in response to a request to register it from the information processing apparatus. The information processing apparatus creates a hot folder for achieving a job flow set by a user after settings of the job flow are performed by the user. An image processing device in which the hot folder is to be registered is specified (hereinafter, referred to sometimes as an image processing device at a registration destination of the hot folder or as an image processing device specified as a registration destination of the hot folder).

However, the image processing device specified as the registration destination of the hot folder may not have a capability supporting the job flow of the hot folder. In this case, even when the hot folder is registered in association with a box in the image processing device, the image processing device cannot process data entered into the box in accordance with the job flow of the hot folder.

### SUMMARY OF THE INVENTION

The present invention provides an information processing apparatus capable of executing a job flow of a job execution folder by use of collaboration between an image processing device specified as a registration destination of the hot folder and another image processing device when the job flow is not executable by the specified image processing device.

According to a first aspect of the present invention, an information processing apparatus capable of creating a job execution folder in which a job flow for operating a processing device to process data input into the processing device is set includes a determining unit, a searching unit, a collaborative job execution folder creating unit, and a registration requesting unit. The determining unit is adapted to refer to capability information that indicates a capability of each of a plurality of processing devices and determine whether a first processing device specified as a registration destination of the created job execution folder by a user is capable of executing the job flow of the created job execution folder. The searching unit is adapted to, when the determining unit determines that the first processing device is not capable of executing the job flow of the created job execution folder, refer to the capability information and search for at least one second processing device for achieving the job flow of the created job execution folder in collaboration with the first processing device. The collaborative job execution folder creating unit is adapted to, when the searching unit finds the second processing device, create a collaborative job execution folder as an alternative to the created job execution folder, the collaborative job execution folder including a first job execution folder for operating the first processing device to execute a first job flow executable by the first processing device and a second job execution folder for operating the second processing device to execute a second job flow executable by the second processing device. The registration requesting unit is adapted to request the first processing device to register the first job execution folder and request the second processing device to register the second job execution folder.

According to a second aspect of the present invention, an information processing method for creating a job execution folder in which a job flow for operating a processing device to process data input into the processing device is set includes referring to capability information that indicates a capability of each of a plurality of processing devices, determining whether a first processing device specified as a registration destination of the created job execution folder by a user is capable of executing the job flow of the created job execution folder, referring to the capability information and searching for at least one second processing device for achieving the job flow of the created job execution folder in collaboration with the first processing device when it is determined that the first processing device is not capable of executing the job flow of the created job execution folder in the determining, creating a collaborative job execution folder as an alternative to the created job execution folder when the second processing device is found in the searching, the collaborative job execution folder including a first job execution folder for operating the first processing device to execute a first job flow executable by the first processing device and a second job execution folder for operating the second processing device to execute a second job flow executable by the second processing device, and requesting the first processing device to register the first job execution folder and requesting the second processing device to register the second job execution folder.

Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a configuration of a system in which an information processing apparatus is connected to a plurality of image processing devices via a network according to an embodiment of the present invention.

FIG. 2 is a block diagram that illustrates a structure of an information processing apparatus (personal computer (PC)) shown in FIG. 1.

FIG. 3 is a block diagram that illustrates a structure of an image processing device shown in FIG. 1.

FIG. 4 illustrates a memory map of a storage device shown in FIG. 3.

FIG. 5 is a plan view that illustrates a key layout of an operation portion shown in FIG. 3.

FIG. 6 is a vertical sectional view that illustrates an internal structure of the image processing device shown in FIG. 1.

FIG. 7A is a flowchart that illustrates a process for entering document data into a box of the image processing device from a PC shown in FIG. 1, and FIG. 7B is a flowchart that illustrates a process for storing document data received by the image processing device in the box.

FIG. 8 is a flowchart that illustrates a process occurring when the image processing device enters image data obtained by a reader portion reading an original into a box of the image processing device.

FIG. 9 illustrates one example of a screen used for selection of a box in the image processing device.

FIG. 10 illustrates one example of a screen for prompting for a password appearing when a box number is selected on the selection screen shown in FIG. 9.

FIG. 11 illustrates one example of a screen that displays a list of data stored in the selected box.

FIG. 12 is a flowchart that illustrates a process for registering a hot folder in one of image processing devices on a local area network (LAN) from a PC shown in FIG. 1.

FIG. 13 illustrates one example of a hot folder editing screen displayed on a PC shown in FIG. 1.

FIG. 14 illustrates one example of a screen used for selection of a registration destination of a hot folder from a PC shown in FIG. 1.

FIG. 15 illustrates one example of a selection screen for prompting a user to select one desired combination from a list of combinations of an image processing device at a registration destination and other image processing devices capable of collaborating therewith.

### DESCRIPTION OF THE EMBODIMENTS

Embodiments of the present invention will be described below with reference to the drawings.

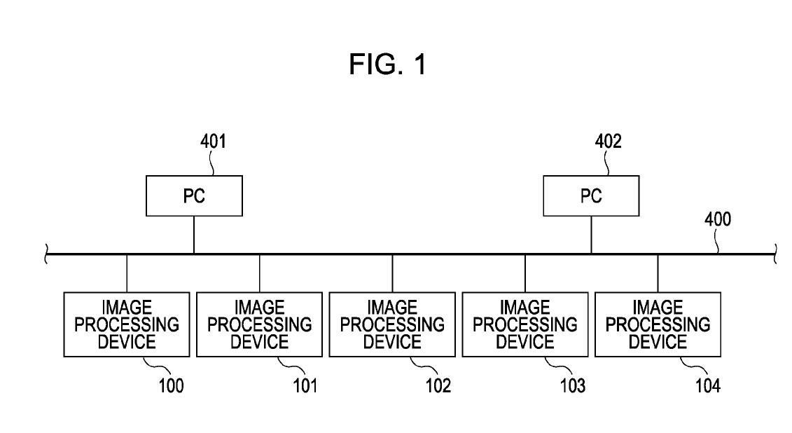

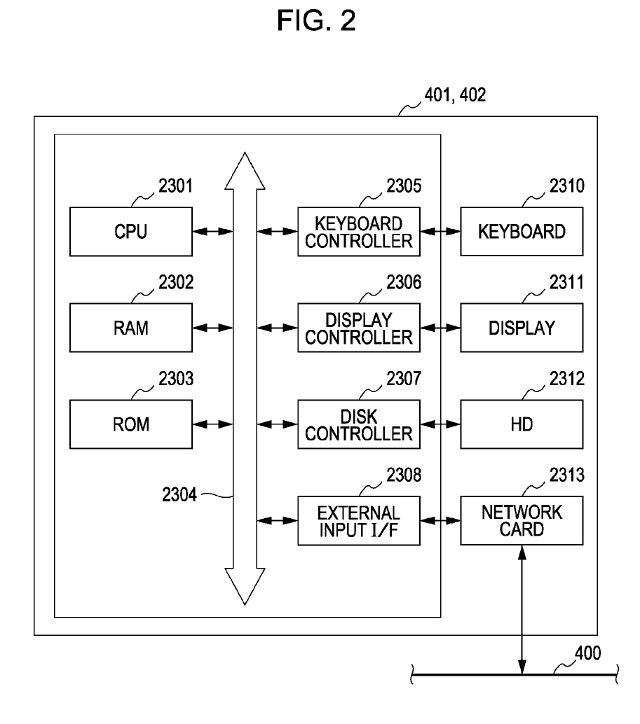

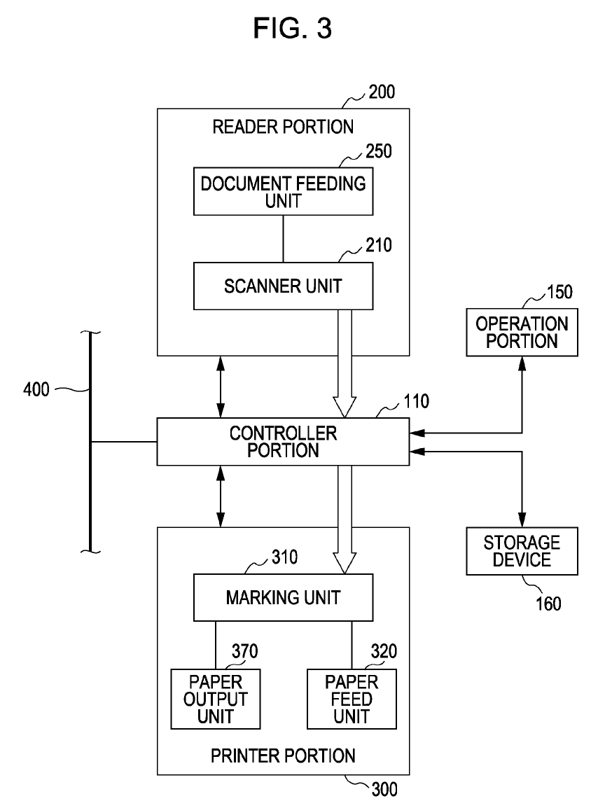

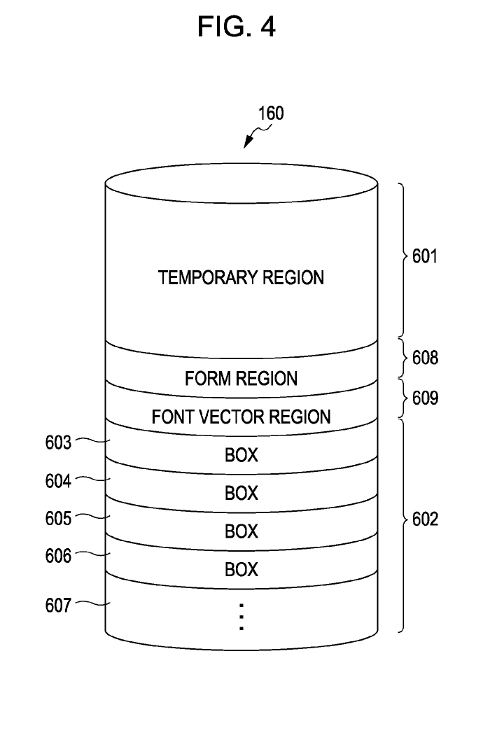

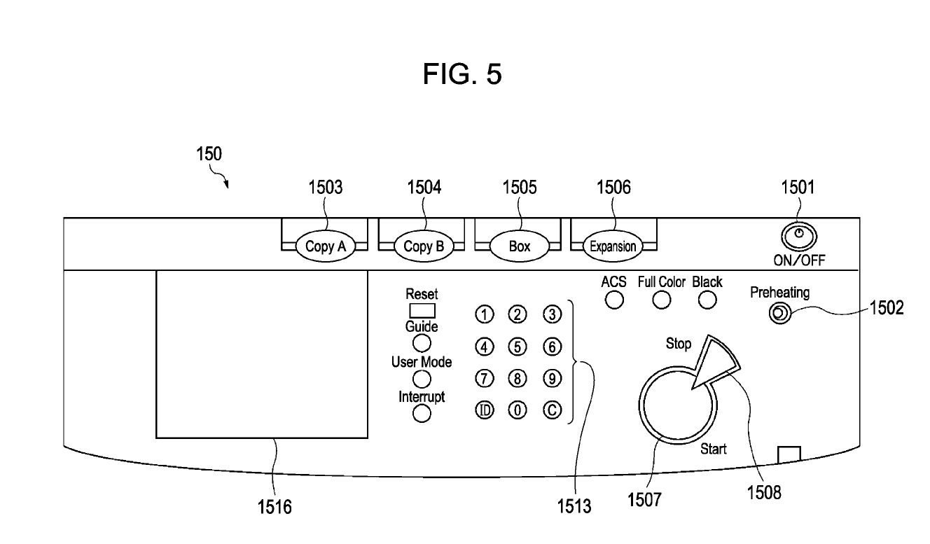

FIG. 1 illustrates a configuration of a system in which an information processing apparatus is connected to a plurality of image processing devices via a network according to an embodiment of the present invention. FIG. 2 is a block diagram that illustrates a structure of an information processing apparatus (personal computer (PC)) shown in FIG. 1. FIG. 3 is a block diagram that illustrates a structure of an image processing 100 shown in FIG. 1. FIG. 4 illustrates a memory map of a storage 160 shown in FIG. 3. FIG. 5 is a plan view that illustrates a key layout of an operation portion 150 shown in FIG. 3.

In the present embodiment, as illustrated in FIG. 1, a plurality of information processing apparatuses 401 and 402 are connected to a plurality of image processing devices 100, 101, 102, 103, and 104 via a network, for example, a local area network (LAN) 400.

Each of the information processing apparatuses 401 and 402 can be, for example, a personal computer. As illustrated in FIG. 2, each of the information processing apparatuses (hereinafter referred to as PCs) 401 and 402 includes a central processing unit (CPU) 2301, a random-access memory (RAM) 2302, and a read-only memory (ROM) 2303. The CPU 2301 launches an operating system (OS) in accordance with a program stored in the ROM 2303 and executes a program read from a hard disk device (hereinafter referred to as an HD) 2312 on the OS. In response to this, processing for the executed program is performed. At this time, the CPU 2301 performs computations using a working area provided by the RAM 2302.

The CPU 2301 is connected to a keyboard controller 2305, a display controller 2306, a disk controller 2307, and an external input interface (I/F) 2308 via an internal bus 2304.

The keyboard controller 2305 is connected to a keyboard 2310 and a mouse (not shown) and transmits, to the CPU 2301, information input from a user via the keyboard 2310 or the mouse.

The display controller 2306 is connected to a display 2311 (e.g., a liquid crystal display) and displays information transmitted from the CPU 2301 on the display 2311.

The disk controller 2307 is connected to the HD 2312 and controls writing of data into the HD 2312 and reading of data therefrom.

The external input I/F 2308 is connected to a network card 2313 and controls transmission and reception of data between the PCs 401 and 402 and the image processing devices 100 to 104 on the LAN 400 via the network card 2313.

The image processing 100 is a digital multifunction peripheral, which has multiple capabilities. As illustrated in FIG. 3, the image processing 100 includes a reader portion 200, a printer portion 300, a controller portion 110, the storage device 160, and the operation portion 150. The reader portion 200 includes a scanner unit 210 configured to optically read an image on an original and output image data of the read image and a document feeding unit 250 configured to feed an original to the scanner unit 210.

The printer portion 300 includes a marking unit 310, a paper feed unit 320, and a paper output unit 370. The marking unit 310 forms an image represented by image data output from the reader portion 200 or by image data input from the information processing apparatus 401 or 402 via the LAN 400 on a sheet fed from the paper feed unit 320. The sheet with the image formed thereon is conveyed to the paper output unit 370. The paper output unit 370 performs postprocessing, such as sorting, stapling, folding, and bookbinding, on the sheet with the image formed thereon and outputs the sheet to the outside of the image processing device.

The controller portion 110 controls the reader portion 200 and the printer portion 300 and provides various capabilities. More specifically, the controller portion 110 provides copying capability of reading an image on an original using the reader portion 200 and forming an image of the read image on a sheet and outputting the sheet using the printer portion 300. The controller portion 110 also provides scanning capability of converting image data obtained by the reader portion 200 reading an original into code data and transmitting the code data to the PC 401 or 402 via the LAN 400. In addition, the controller portion 110 provides printing capability of converting code data received from the PC 401 or 402 via the LAN 400 into image data and outputting it to the printer portion 300. The controller portion 110 further provides file conversion capability of converting code data received from the PC 401 or 402 via the LAN 400 or image data obtained by the reader portion 200 reading an original into data in predetermined format.

The storage 160 can include, for example, a storage medium (e.g., a hard disk device). The storage 160 can store image data, control data, and programs. A plurality of boxes can be registered in the storage device 160. Each of the boxes is a storage area in the storage device 160. Data, such as image data, can be entered in the box or extracted therefrom. The box can be assigned to each user or each division. Each box can be associated with a job execution folder in which a job flow is set (hereinafter referred to as a hot folder). The hot folder is registered in the storage 160 in association with a corresponding box in response to a request to register it from the PC 401 or 402. When data, such as image data, is entered into a box associated with a hot folder, the entered data is processed in accordance with a job flow of that hot folder using a capability of the image processing device 100.

More specifically, as illustrated in FIG. 4, the storage 160 has logically separated regions, including a temporary region 601, a box region 602, a form region 608, and a font vector region 609. The box region 602 is a storage area for achieving box capability. A predetermined number of boxes 603 to 607, . . . can be registered in the box region 602. Each of the boxes 603 to 607, . . . can be assigned to a user, a division of a company, or other classes. Each of the boxes 603 to 607, . . . is given identifying information (e.g., a box number) and a password. A user can specify a corresponding box by performing a predetermined operation on the PC 401 or 402 or on the operation portion 150 of the image processing device 100 and store desired data in the box. At this time, authentication is performed through a password to protect the box against unauthorized access from a third party. Each of the boxes 603 to 607, . . . can be associated with a hot folder created by the PCs 401 and 402. The hot folder is registered in the box region 602 in association with the corresponding box.

As illustrated in FIG. 5, the operation portion 150 has a plurality of hard keys, including a numeric keypad for receiving a numerical value and a key for setting a mode. For example, a power switch 1501, a preheating key 1502, an A-mode copy key 1503, a B-mode copy key 1504, a box key 1505, an expansion key 1506, a copy start key 1507, a stop key 1508, and a numeric keypad 1513 are included.

The box key 1505 is used for selection of box capability. Pressing the box key 1505 activates the box capability. The box capability includes generation, registration, and editing of a box, entering (storing) of data into a box, and extracting (reading) of data from a box.

The operation portion 150 also includes a touch-screen liquid crystal display panel (hereinafter referred to as an LCD) 1516. A setting user interface for each mode and a plurality of soft keys relating to settings of the mode are displayed on the LCD 1516. The use of these soft keys enables various advanced settings and the inputting of a numeric value. A status of the device and an operating state of each job are also displayed on the LCD 1516.

Information input from a user through the operation portion 150 (e.g., a numeric value and settings) is input into the controller portion 110. The controller portion 110 performs processing or settings based on the input information.

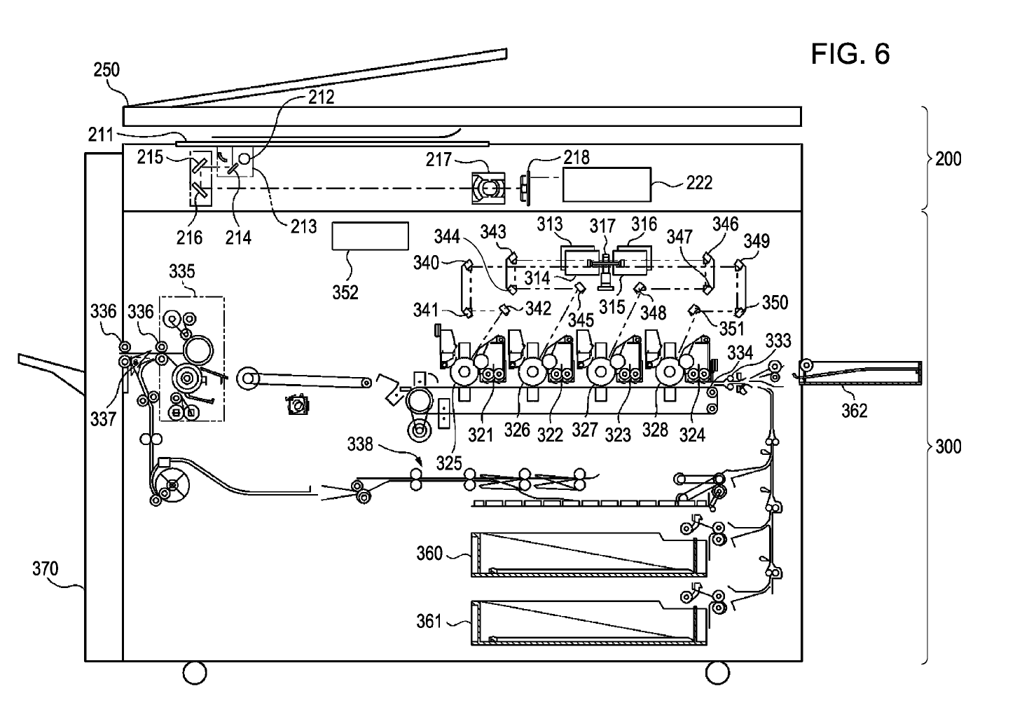

An example structure of the reader portion 200 and the printer portion 300 of the image processing 100 will now be described below with reference to FIG. 6. FIG. 6 is a vertical sectional view that illustrates an internal structure of the image processing 100 shown in FIG. 1.

As illustrated in FIG. 6, the reader portion 200 includes the document feeding unit 250 and the scanner unit 210 (see FIG. 3). The document feeding unit 250 feeds originals one by one from the leading one onto a platen glass 211 and ejects the original onto an original output tray (not shown) after the completion of reading the original.

The scanner unit 210 includes an optical unit 213 having a lamp 212 and a reflector 214 and being movable in a sub scanning direction. When an original is conveyed onto the platen glass 211, the optical unit 213 lights the lamp 212 and moves in the sub scanning direction to scan the original. Light reflected from the original forms an optical image on a charge-coupled device (CCD) image sensor(hereinafter referred to as a CCD) 218 via mirrors 214, 215, and 216 and a lens 217. The CCD 218 converts the optical image into an electrical signal by photoelectric conversion and outputs it. The electrical signal output from the CCD 218 is input into an image processing circuit 222. The image processing circuit 222 performs predetermined processing on the input electrical signal to covert it into a digital signal corresponding to R, G, and B (R, G, and B image data). The image data is input into the controller portion 110 (FIG. 3).

The printer portion 300 includes an image processing circuit 352 for converting image data input from the reader portion 200 or code data input from the PC 401 or 402 via the controller portion 110 into data (CMYK) processable by the printer portion 300. Data obtained by conversion performed by the image processing circuit 352 is input into a laser driver 317. The laser driver 317 drives laser emitters 313, 314, 315, and 316 based on the input data. In response to this, a laser beam based on the image data is emitted from each of the laser emitters 313, 314, 315, and 316. Photosensitive drums 325, 326, 327, and 328 are irradiated with the corresponding laser beams from the laser emitters 313, 314, 315, and 316 via corresponding mirrors 340 to 351. A latent image based on the corresponding laser beam is formed on each of the photosensitive drums 325, 326, 327, and 328.

Developing devices 321, 322, 323, and 324 are arranged around the photosensitive drums 325, 326, 327, and 328, respectively. The developing devices 321, 322, 323, and 324 supply toners of black (Bk), yellow (Y), cyan (C), and magenta (M) to the photosensitive drums 325, 326, 327, and 328, respectively, and develop (visualize) the latent images formed on the photosensitive drums 325, 326, 327, and 328 as a toner image, respectively.

The toner images formed on the photosensitive drums 325 to 328 are transferred to a sheet conveyed by a transfer belt 334 such that they are superimposed to form a full-color toner image on the sheet. The sheet is fed from any one of paper cassettes 360 and 361 and a manual feed tray 362 and is temporarily stopped at a registration roller 333. The sheet is then sent onto the transfer belt 334 by the registration roller 333 with the timing of starting image formation. The transfer belt 334 attracts the sheet and conveys it. The paper cassettes 360 and 361 and the manual feed tray 362 are included in the paper feed unit 320.

The sheet with the toner image formed thereon is conveyed to a fixing portion 335. The fixing portion 335 fixes the toner image formed on the sheet by applying heat and pressure to the sheet. In such a way, the image is formed on the sheet. The sheet passing through the fixing portion 335 is sent to the paper output unit 370 by ejection rollers 336. The paper output unit 370 performs various types of postprocessing, such as generating a batch of sheets, sorting, and stapling of the sorted batch of sheets.

In the duplex mode, which forms an image on both sides of a sheet, after the sheet is conveyed to the location of the ejection rollers 336, the ejection rollers 336 are rotated reversely. The sheet is then guided to a refeeding path 338 by a flapper 337. The sheet guided to the refeeding path 338 is sent to the transfer belt 334 with the above described timing.

The detailed structure of the image processing 100 is described above. The other image processing devices 101 to 104 are digital multifunction peripherals having substantially the same structure as in the image processing device 100. The description of an example structure of each of the image processing devices 101 to 104 is not repeated here.

However, it is to be noted that the capabilities of the image processing devices 100 to 104 are different in that a part of processing in the same capabilities can be performed or not. In the present embodiment, as illustrated in Table 1, some image processing devices cannot perform a part of postprocessing in copy capability and printing capability. This depends on the difference of the capabilities of the paper output unit among the image processing devices. As illustrated in Table 2, in file conversion capability, some image processing devices can convert data into JPEG or TIFF format, but cannot convert data into PDF format.

TABLE 1

| Image Processing | Duplex | | | |
|---|---|---|---|---|
| Device (Name) | Printing | Bookbinding | Stapling | Sorting |
| 100 | ◯ | X | ◯ | ◯ |
| (Device A) | | | | |
| 101 | ◯ | X | X | X |
| (Device B) | | | | |
| 102 | ◯ | ◯ | ◯ | ◯ |
| (Device C) | | | | |
| 103 | ◯ | ◯ | ◯ | ◯ |
| (Device D) | | | | |
| 104 | ◯ | ◯ | ◯ | ◯ |
| (Device E) | | | | |

In the table, ◯ indicates capableness and X indicates incapableness.

TABLE 2

| Image Processing | | | |
|---|---|---|---|
| Device (Name) | PDF | JPEG | TIFF |
| 100 | X | ◯ | ◯ |
| (Device A) | | | |
| 101 | X | ◯ | ◯ |
| (Device B) | | | |
| 102 | ◯ | ◯ | ◯ |
| (Device C) | | | |
| 103 | ◯ | ◯ | ◯ |
| (Device D) | | | |
| 104 | ◯ | ◯ | ◯ |
| (Device E) | | | |

In the table, ◯ indicates capableness and X indicates incapableness.

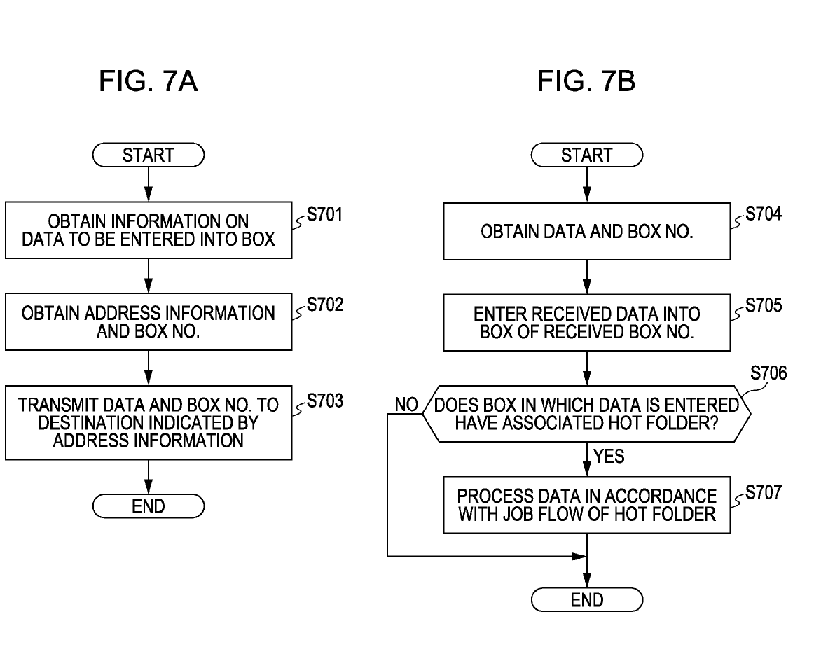

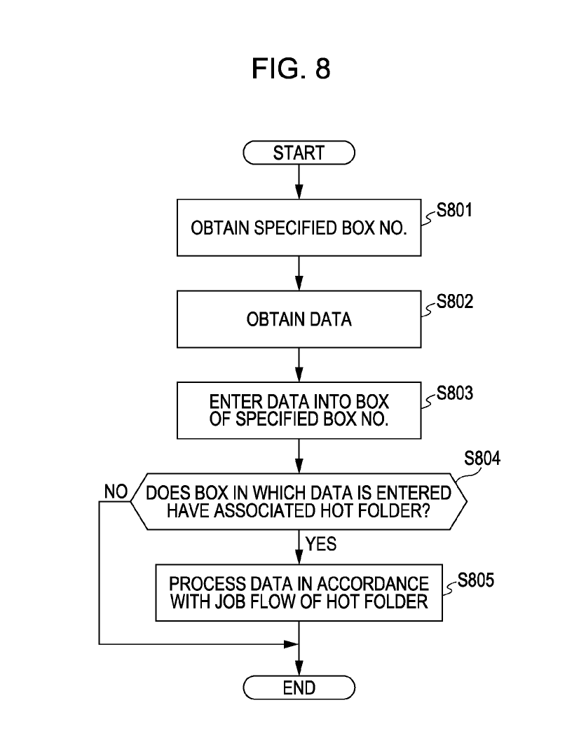

Next, the box capability according to the present embodiment will now be described below with reference to FIGS. 7A, 7B, and 8. FIG. 7A is a flowchart that illustrates a process for entering document data into a box of the image processing 100 from the PC 401. FIG. 7B is a flowchart that illustrates a process for entering document data received by the image processing 100 into the box. FIG. 8 is a flowchart that illustrates a process occurring when the image processing 100 enters image data obtained by the reader portion 200 reading an original into the box of the image processing device 100.

As described above, the box capability is a capability of entering data into a box specified from among a plurality of boxes of the image processing devices 100 to 104 and temporarily storing the data. The data stored in the box is extracted as needed and processed. Each of the boxes is given a box number. The box is specified by use of the box number.

For example, to enter document data generated by the PC 401 into a box of the image processing 100 from the PC 401, as shown in step S701 of FIG. 7A, first, the CPU 2301 of the PC 401 obtains information on data to be entered into the box. Here, information on the name of data to be entered into the box and parameters relating to processing for the data is input by an operation of the keyboard 2310 or the mouse on a screen appearing on the display 2311 of the PC 401, for example. In the case of printing the document data out, examples of the parameters include parameters for the number of copies, the size of a sheet, the scaling factor, single-sided/duplex printing, the sequence of outputting pages, and the presence or absence of sorting in outputting and stapling. The input information is obtained by the CPU 2301 as information on data to be entered into the box.

Then, in step S702, the CPU 2301 obtains, as information used for specifying a box into which the data is to be entered, address information for an image processing device to which the data is to be transmitted and the box number of a box of the image processing device. Here, the address information for the device to which the data is to be transmitted and the box number are input by an operation of the keyboard 2310 or the mouse on a screen appearing on the display 2311. The input address information and box number are obtained by the CPU 2301.

Then, in step S703, the CPU 2301 reads data corresponding to the obtained information from the HD 2312 and transmits the read data together with the parameters relating to the processing for the data and the box number to the destination indicated by the address information. The CPU 2301 then ends the process.

In the image processing device 100, as shown in step S704 of FIG. 7B, the controller portion 110 receives the data and the box number transmitted from the PC 401. Then, in step S705, the controller portion 110 enters (stores) the received data into the box of the received box number.

Then, in step S706, the controller portion 110 determines whether the box in which the data is entered has a hot folder associated therewith. When the box does not have any associated hot folder (NO in step S706), the controller portion 110 ends the process. In contrast, when the box has an associated hot folder (YES in step S706), the controller portion 110 processes the data entered into the box using the corresponding capability in accordance with a job flow of the hot folder in step S707. The controller portion 110 then ends the process.

Next, inputting data in the image processing device 100 and entering the input data into a box of the image processing 100 will now be described below.

In this case, as shown in step S801 of FIG. 8, first, the controller portion 110 obtains a box number specified by a user through the operation portion 150 as the box number of a box into which data is to be entered. Here, an operation screen used for specifying the box number of the box into which data is to be entered is displayed on the LCD 1516 of the operation portion 150 by the controller portion 110. The box number specified by the user on the operation screen is obtained by the controller portion 110.

Then, in step S802, the controller portion 110 obtains input data as data to be entered into the box. Here, the input data is image data obtained by the reader portion 200 of the image processing 100 reading an original. To input image data obtained by the reader portion 200 reading an original, a user first places the original on the reader portion 200 and then performs an operation for reading the placed original. At this time, parameters relating to reading of the original (e.g., the resolution for reading, enlarging/reducing) are set, and the original is read in accordance with the set parameters. The image data obtained by the reader portion 200 reading the original is input to the controller portion 110.

Then, in step S803, the controller portion 110 enters (stores) the image data input from the reader portion 200 into the box of the box number.

Then, in step S804, the controller portion 110 determines whether the box in which the data is stored has a hot folder associated therewith. When the box does not have any associated hot folder (NO in step S804), the controller portion 110 ends the process. In contrast, when the box has an associated hot folder (YES in step S804), the controller portion 110 processes the data entered in the box using the corresponding capability in accordance with a job flow of the hot folder in step S805. The controller portion 110 then ends the process.

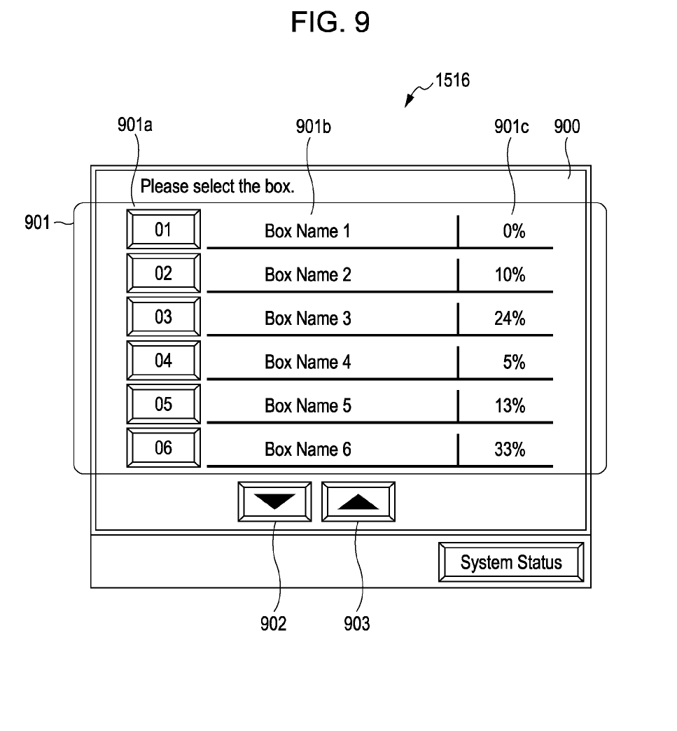

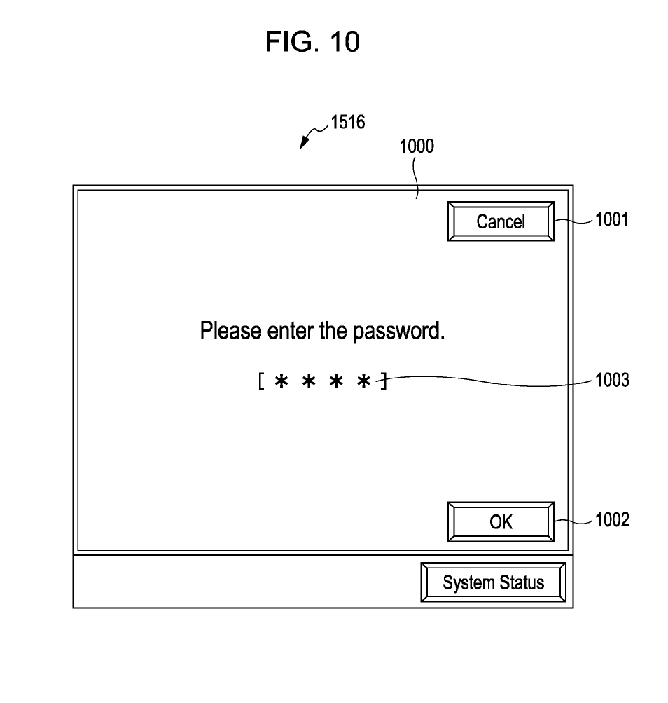

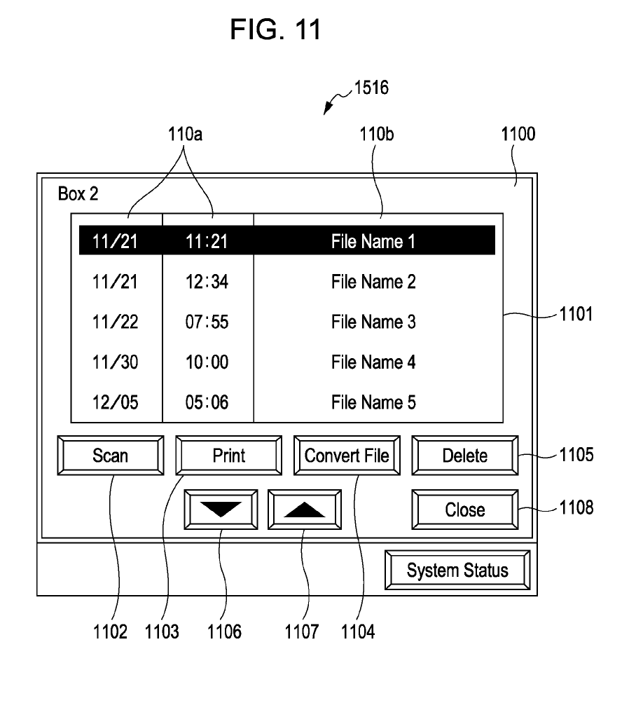

Next, an operation for selecting a box in the image processing device 100, an operation for entering data into the selected box, and an operation for selecting processing to be performed on the data entered in the box will now be described below with reference to FIGS. 9 to 11. FIG. 9 illustrates one example of a screen used for selection of a box in the image processing device 100. FIG. 10 illustrates one example of a screen for prompting for a password appearing when a box number is selected on the selection screen shown in FIG. 9. FIG. 11 illustrates one example of a screen that displays a list of data entered in the selected box.

To use the box capability in the image processing device 100, the box key 1505 of the operation portion 150 is pressed by a user. When the box key 1505 is pressed, a box selection screen 900 that shows a box list 901 of boxes set in the image processing 100 is displayed on the LCD 1516 of the operation portion 150, as illustrated in FIG. 9. In the box list 901, a box number key 901a, a box name 901b, and information 901c indicating available storage capacity of the box are displayed in association with each other for each box. Vertical scroll keys 902 and 903 used for scrolling the box list 901 up and down are displayed on the box selection screen 900.

When the box number key 901a for a desired box is pressed, a password entry screen 1000 is displayed, as illustrated in FIG. 10. The password entry screen 1000 has a password entry field 1003 for receiving a password. To cancel an input password, a cancel key 1001 is pressed. To confirm an input password, an OK key 1002 is pressed. When the OK key 1002 is pressed, authentication through the password is performed. When the input password does not correspond with a previously set password, a warning screen indicating that is displayed on the LCD 1516.

In contrast, when the input password corresponds with the previously set password, a data list screen 1100 of data stored in the selected box is displayed, as illustrated in FIG. 11. A data list 1101 of data stored in the box is displayed on the data list screen 1100. A registration date and time 110a and a file name key 110b are displayed in the data list 1101 for each data. To select desired data, the file name key 110b for the desired data is pressed. The pressed file name key 110b is highlighted (e.g., displayed in reverse video).

A scan key 1102, a print key 1103, a file conversion key 1104, a delete key 1105, up and down scroll keys 1106 and 1107, and a close key 1108 are displayed on the data list screen 1100. The scan key 1102 is pressed to enter image data obtained by the reader portion 200 reading an original into a currently open box. The print key 1103 is pressed to print data selected on the data list 1101.

The file conversion key 1104 is pressed to convert data selected on the data list 1101 into another format file. When the file conversion key 1104 is pressed, a screen used for selection of an intended file format is displayed. Settings for converting selected data into an intended file format (e.g., TIFF format) are made on this screen. In accordance with the settings, file conversion is performed.

The delete key 1105 is pressed to delete data selected on the data list 1101. The up and down scroll keys 1106 and 1107 are used to scroll the data list 1101. The close key 1108 is used to return to the box selection screen 900 illustrated in FIG. 9.

The operation for selecting a box in an image processing device, the operation for entering data into the selected box, and the operation for selecting processing to be performed on the data stored in the box are also carried out in the other image processing devices 101 to 104 in a similar manner to that in the image processing device 100.

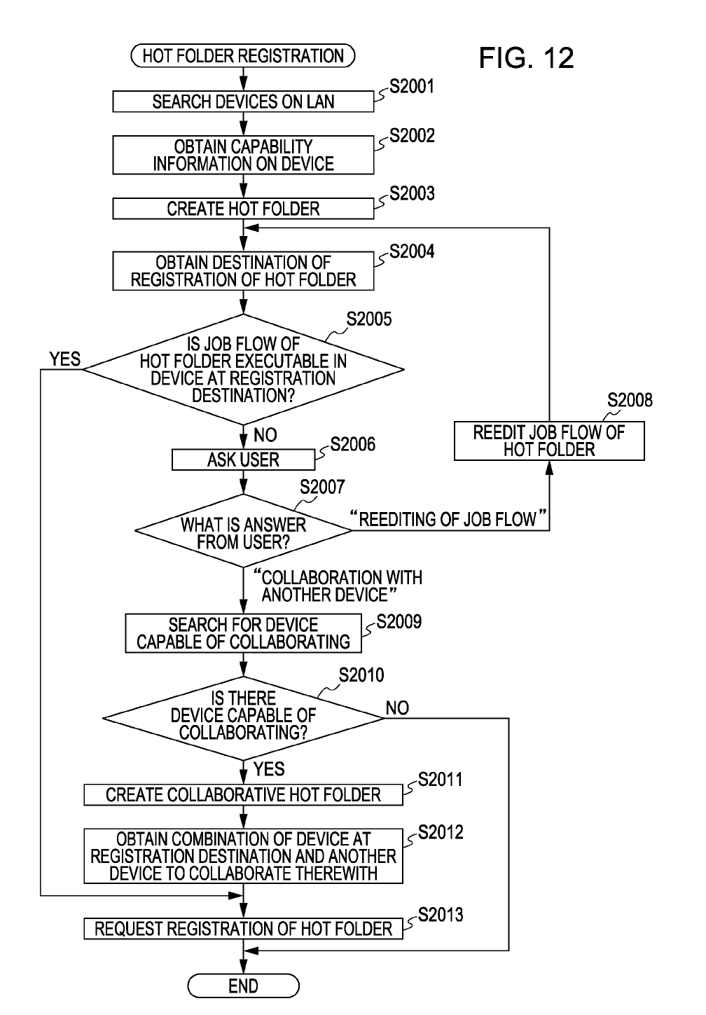

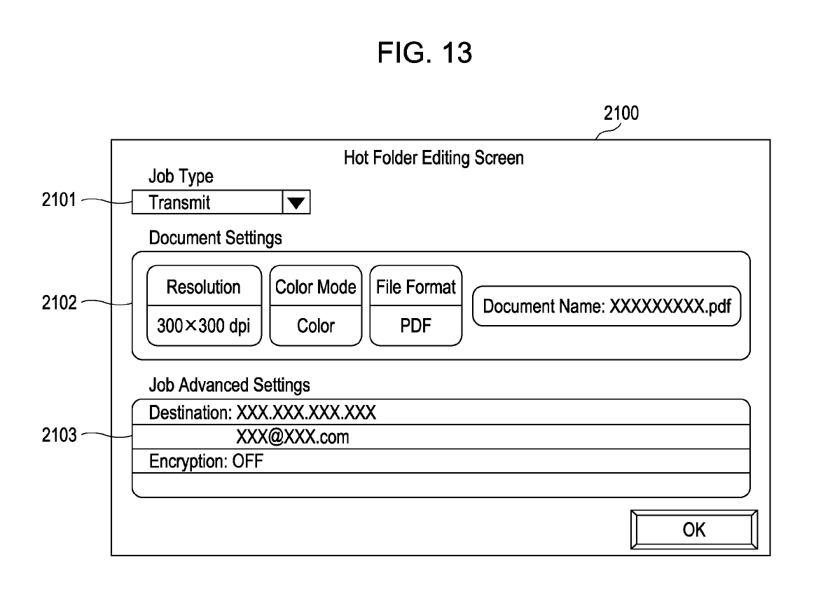

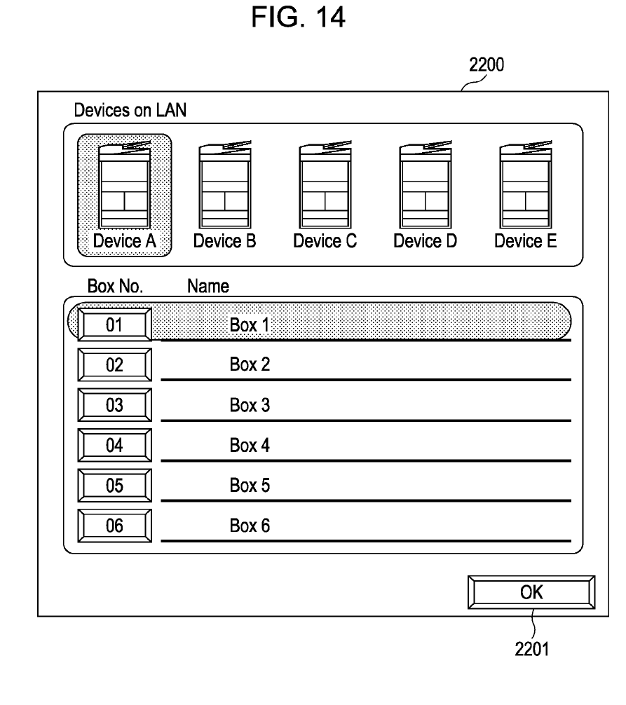

Next, a process for registering a hot folder in one of the image processing devices 100 to 104 on the LAN 400 from the PC 401 or 402 will now be described below with reference to FIGS. 12 to 14. FIG. 12 is a flowchart that illustrates a process for registering a hot folder in one of the image processing devices 100 to 104 on the LAN 400 from the PC 401 or 402. FIG. 13 illustrates one example of a hot folder editing screen displayed on the PC 401 or 402. FIG. 14 illustrates one example of a registration destination selection screen used for selection of an image processing device in which a hot folder is to be registered (the registration destination of the hot folder) from the PC 401 or 402.

For example, to register a hot folder in an image processing device on the LAN 400 from the PC 401, as shown in step S2001 of FIG. 12, first, the CPU 2301 of the PC 401 searches image processing devices present on the LAN 400 for an image processing device capable of registering the hot folder. Here, the search finds the image processing devices 100 to 104 as an image processing device capable of registering the hot folder. Then, in step S2002, the CPU 2301 communicates with each of the image processing devices 100 to 104 on the LAN 400 found by the search and obtains capability information for each of the image processing devices 100 to 104. The capability information is information that indicates the details of the capabilities (e.g., printing capability, e-mail transmitting capability, facsimile transmitting capability, and file converting capability) of each of the image processing devices 100 to 104.

Then, in step S2003, the CPU 2301 creates a hot folder. Here, a hot folder editing screen is displayed on the display 2311. Settings of the type of a job and data to be entered and advanced settings of the job are made by the user on the hot folder editing screen. Here, the type of a job is the type of a job to be performed on data when the data is entered into a box. Examples of the job type include e-mail transmission, facsimile transmission, file conversion, data transfer to another box, and printing in a specified image processing device. Two or more of these types of jobs can be combined and set as a single job.

In the settings of data to be entered, the resolution for data to be entered into a box, the color mode, the file format, the file name, and other items are set. In the advanced settings of a job, when e-mail transmission is specified as the job type, for example, the destination of transmission of data entered in the box is set. When file conversion is specified as the job type, the file format into which the data entered in the box is to be converted is set. When necessary settings are made in such a way, a hot folder for enabling execution of a job flow based on the settings set by the user is created. The details of one example of the hot folder editing screen will be described later.

Then, in step S2004, the CPU 2301 displays a registration destination selection screen used for selection of the registration destination of the hot folder on the display 2311 and obtains the registration destination of the hot folder selected by the user on the registration destination selection screen. A list of candidates for the registration destination (the image processing devices 100 to 104 found in step S2001) is displayed on this registration destination selection screen. When the user selects one device (a first processing device) from the list of candidates for the registration destination, a list of boxes in the selected image processing device is displayed. Then, one box to be associated with the hot folder is selected from the list of boxes. The selected image processing device is obtained as the registration destination of the created hot folder, and the selected box is obtained as the box to be associated with the hot folder. The details of one example of the registration destination selection screen will be described later.

Then, in step S2005, the CPU 2301 refers to the capability information for each of the image processing devices 100 to 104 obtained in step S2002 and determines whether the image processing device at the registration destination can execute the job flow of the hot folder. When it is determined that the image processing device at the registration destination can execute the job flow of the hot folder (YES in step S2005), the CPU 2301 requests the image processing device at the registration destination to register the hot folder in association with the selected box in step S2013. In making this request, together with transmission of the hot folder, the box to be associated with the hot folder is specified. The image processing device that has received this request registers the hot folder in association with the box. The CPU 2301 then ends the process.

When it is determined that the image processing device at the registration destination cannot execute the job flow of the hot folder (NO in step S2005), the CPU 2301 asks the user in step S2006. Here, an inquiry screen is displayed on the display 2311. The inquiry screen displays a message saying that the image processing device at the registration destination cannot execute the job flow of the hot folder and inquiring of the user which he/she selects, “reediting of the job flow” or “collaboration with another device”. Either one of “reediting of the job flow” and “collaboration with another device” is selected as an answer from the user on this inquiry screen.

Then, in step S2007, the CPU 2301 determines whether the answer from the user on the inquiry screen is “reediting of the job flow” or “collaboration with another device”. When it is determined that the answer is “reediting of the job flow” in step S2007, the CPU 2301 reedits the job flow of the hot folder in response to a reediting operation from the user in step S2008. Here, a reediting screen used for reediting the job flow of the hot folder is displayed on the display 2311. The reediting screen is similar to the hot folder editing screen displayed in step S2003. The job flow is reedited by an operation on this reediting screen so as to have the content executable by the image processing device at the registration destination. When the job flow is reedited in step S2008, flow returns to step S2004, where the CPU 2301 obtains the registration destination of the hot folder. Then, flow proceeds to step S2005.

When it is determined that the answer from the user is “collaboration with another device” in step S2007, the CPU 2301 refers to the capability information and searches for an image processing device capable of collaborating with the image processing device at the registration destination (second processing device) in step S2009. The image processing device capable of collaborating with the image processing device at the registration destination is another image processing device that has a capability necessary for making a job flow that is not executable by the image processing device at the registration destination executable. In step S2010, the CPU 2301 determines whether there exists an image processing device capable of collaborating with the image processing device at the registration destination.

When it is determined that there is not an image processing device capable of collaborating with the image processing device at the registration destination (NO in step S2010), it is impossible to execute the job flow of the created hot folder by use of collaboration between the image processing device at the registration destination and another image processing device capable of collaborating therewith. Therefore, the CPU 2301 ends the process. At this time, a message saying that it is impossible to execute the job flow of the created hot folder by use of collaboration between the image processing device at the registration destination and another image processing device capable of collaborating therewith is displayed on the display 2311.

When it is determined that there exists an image processing device capable of collaborating with the image processing device at the registration destination (YES in step S2010), a collaborative hot folder is created in step S2011. Here, the CPU 2301 refers to the capability information and sets a first job flow employing the capability of the image processing device at the registration destination and a second job flow employing the capability of the image processing device capable of collaborating therewith. The first job flow is a job flow from processing of data entered in the specified box of the image processing device at the registration destination employing the capability thereof to entering of the processed data into a corresponding box of the image processing device capable of collaborating therewith. The second job flow is a job flow from processing of data, the data being entered in the corresponding box of the image processing device capable of collaborating in accordance with the first job flow, employing the capability thereof to outputting of the processed data. A box into which data is to be entered in accordance with the first job flow of the image processing device capable of collaborating (a box to be associated with the second job flow) is determined by the CPU 2301.

In such a way, to achieve the job flow of the crated hot folder by use of collaboration between the image processing device at the registration destination and the image processing device capable of collaborating therewith, the first job flow and the second job flow collaborating therewith are set. A first hot folder for operating the image processing device at the registration destination to execute the first job flow (first job execution folder) is created by the CPU 2301. Similarly, a second hot folder for operating the image processing device capable of collaborating with the image processing device at the registration destination to execute the second job flow (second job execution folder) is created.

When the first and second hot folders are created in such a way, the CPU 2301 then obtains a combination of the image processing device at the registration destination and the image processing device capable of collaborating therewith selected by the user in step S2012. In this selection, a selection screen that presents a list of combinations of the image processing device at the registration destination and image processing devices capable of collaborating therewith to the user and prompts the user to select one desired combination from the list is displayed on the display 2311. The one combination selected by the user on the selection screen is obtained by the CPU 2301.

As an alternative to this selection screen, a selection screen that presents a list of the image processing device at the registration destination and image processing devices capable of collaborating therewith and prompts the user to select one desired image processing device capable of collaborating may be displayed on the display 2311.

Then, in step S2013, the CPU 2301 requests the image processing device at the registration destination included in the obtained one combination to register the first hot folder in association with a corresponding box. Here, the box associated with the first hot folder is the box of the box number obtained in step S2004. The CPU 2301 also requests the image processing device capable of collaborating included in the obtained one combination to register the second hot folder in association with a corresponding box. Here, the box associated with the second hot folder is the box determined by the CPU 2301. In response to the request, the image processing device at the registration destination registers the first hot folder in association with the corresponding box, and the image processing device capable of collaborating therewith registers the second hot folder in association with the corresponding box. Then, the CPU 2301 ends the process.

In step S2003, a hot folder editing screen 2100, as illustrated in FIG. 13, is displayed, for example. The hot folder editing screen 2100 includes a job type entry field 2101, a document settings entry field 2102 for settings of data to be entered, and a job advanced settings entry field 2103. The job type is the type of a job to be performed on data when the data is entered into a box. Examples of the job type include e-mail transmission, facsimile transmission, data conversion, data transfer to another box, and printing in a specified image processing device. Two or more of these types of jobs can be combined and set as a single job.

In the settings of data to be entered, the resolution for data to be entered into a box, the color mode, the file format, the file name, and other items are set. In the advanced settings of a job, when e-mail transmission is specified as the job type, for example, the destination of transmission of data entered in the box is set. When data conversion is specified as the job type, the file format into which the data entered in the box is to be converted is set. When necessary settings are made in such a way, a hot folder in which a job flow based on the content of settings is set is created.

In step S2004, a registration destination selection screen 2200, as illustrated in FIG. 14, is displayed on the display 2311, for example. The registration destination selection screen 2200 displays a list of candidates for the registration destination (the image processing devices 100 to 104 found in step S2001). If the user selects the image processing 100 from the list of candidates for the registration destination, a list of boxes in the selected image processing 100 is displayed. Then, the box number of the box to be associated with the hot folder is selected by the user from the list of boxes. When an OK key 2201 is pressed, the image processing device selected by the user is confirmed as the registration destination, and the box of the selected box number is confirmed as the box to be associated with the hot folder.

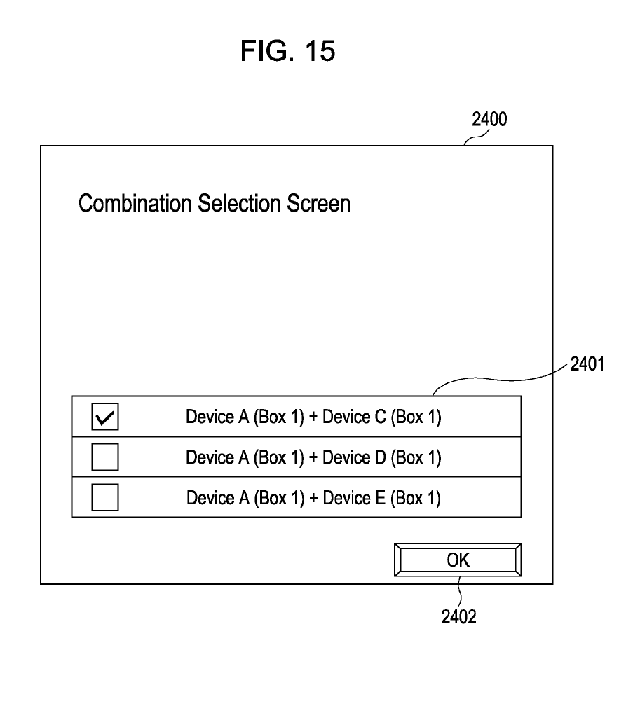

Next, example creation of a hot folder for enabling collaboration between the image processing device at the registration destination and another image processing device in step S2011 of FIG. 12 will now be described below with reference to FIG. 15. FIG. 15 illustrates one example of a selection screen for prompting a user to select one desired combination from a list of combinations of the image processing device at the registration destination and other image processing devices capable of collaborating therewith.

Here, it is assumed that a hot folder for enabling execution of the next job flow is created in the PC 401 (in step S2003). This job flow is assumed to be a job flow for “converting data entered in a box into PDF format employing the file conversion capability and transferring the PDF data to the PC 402”. It is also assumed that the image processing 100 is specified by the user as the registration destination of the hot folder and the box of the box number 1 of the image processing 100 is specified as the box to be associated with the hot folder (in step S2004).

In this case, as illustrated in Table 1, because the image processing 100 does not have the file conversion capability of converting data into PDF format, the job flow of the hot folder is not executable (NO in step S2005). Therefore, to achieve the job flow by use of collaboration between the image processing 100 and another image processing device, an image processing device that has the file conversion capability of converting data into PDF format is searched for (in step S2009). This search finds the image processing devices 102 to 104 as an image processing device that has the file conversion capability of converting data into PDF format and that is capable of collaborating with the image processing device 100.

Then, a first job flow of “transferring data entered in the box of the box number 01 of the image processing 100 to a corresponding box of the image processing devices 102 to 104 is set (in step S2011). A first hot folder for operating the image processing device 100 to execute the first job flow is created. A second job flow of “converting data entered in the corresponding box of the image processing devices 102 to 104 into PDF format and transferring the PDF data to the PC 402” is set. A second hot folder for operating the image processing devices 102 to 104 to execute the second job flow is created.

Here, a box into which data is to be entered in accordance with the first job flow of the image processing device capable of collaborating (a box to be associated with the second job flow) is determined by the CPU 2301. Here, it is assumed that the box of the box number 1 is determined as the box to be associated with the second job flow of the image processing devices 102 to 104.

Then, a selection screen for prompting the user for a desired combination from the list of combinations of the image processing 100 and the image processing devices 102 to 104 capable of collaborating therewith is displayed on the display 2311. One example of the selection screen displayed on the display 2311 is a selection screen 2400 illustrated in FIG. 15. The combinations of “Device A (Box 1)+Device C (Box 1)”, “Device A (Box 1)+Device D (Box 1)”, . . . are displayed in a list 2401 of combinations of the image processing 100 and the image processing devices 102 to 104 on the selection screen 2400. Here, the device A is the name of the image processing device 100, and the box 1 inside the parentheses is the name of the box of the box number 1 to be associated with the first hot folder. Similarly, the devices C and D are the names of the image processing devices 102 and 103, and the box 1 inside the parentheses is the name of the box of the box number 1 to be associated with the second hot folder. When one combination is selected from the list by the user and an OK key 2402 is pressed, the image processing device with which the image processing 100 is to collaborate is confirmed.

Here, it is assumed that the combination “Device A (Box 1)+Device C (Box 1)” is selected by the user on the selection screen 2400. In this case, the job flow of the first hot folder is a job flow of “transferring data entered in the box of the box number 1 to the box of the box number 01 of the image processing device 102”. The image processing 100 is requested to register the first hot folder in association with the box of the box number 1.

The job flow of the second hot folder is a job flow of “converting data entered in the box of the box number 1 into PDF format and transferring the PDF data to the PC 402”. The image processing device 102 is requested to register the second hot folder in association with the box of the box number 1.

Another example is that a hot folder for execution of a job flow of “printing document data entered in a box and binding the printed material into a book employing bookbinding capability” is created in the PC 401. It is assumed that the user specifies the image processing device 100 as the registration destination of the hot folder and specifies the box of the box number 1 of the image processing 100 as the box to be associated with the hot folder.

In this case, because the image processing device 100 does not have the bookbinding capability, the image processing 100 cannot execute the job flow of the hot folder. Therefore, the image processing devices 102 to 104 are found as an image processing device that has the bookbinding capability and that is capable of collaborating with the image processing device 100. Then, the first hot folder for operating the image processing 100 to execute the job flow of “transferring document data entered in the box of the box number 01 of the image processing 100 to a corresponding box of the image processing devices 102 to 104” is created. The second hot folder for operating the image processing devices 102 to 104 to execute the job flow of “printing the document data entered in the corresponding box of the image processing devices 102 to 104 and binding the printed material into a book” is created.

Then, a combination of the image processing device 100 and an image processing device with which the image processing 100 is to collaborate is selected by the user on a similar selection screen to that described above. The image processing 100 and the image processing device with which the image processing 100 is to collaborate of the selected combination are requested to register the first hot folder and the second hot folder, respectively.

In such a way, according to the present embodiment, even when an image processing device at the registration destination does not have a capability necessary for executing a job flow of a hot folder, the job flow is made executable by use of collaboration between the image processing device at the registration destination and another image processing device. This saves the user from having to check whether the image processing device at the destination of registration of a hot folder has a capability for enabling execution of the job flow of the hot folder even time the necessity to register a hot folder arises. As a result, time and effort required for registering a hot folder can be reduced.

In the present embodiment, a job flow that uses the file conversion capability or the bookbinding capability is made executable by use of collaboration between an image processing device at the registration destination and another image processing device. However, the present invention is not limited to this example.

In the present embodiment, if a job flow is not executable by a single image processing device, two image processing devices collaborate to make the job flow executable. However, the job flow can be made executable by use of collaboration of three or more image processing devices.

The present invention can be achieved by the following processing. That is, the processing is to supply a storage medium that stores program code of software for realizing the above described embodiment to a system or an apparatus and read the program code stored in the storage medium by a computer (or CPU, microprocessor unit (MPU)) in the system or apparatus.

In this case, program code in itself read from a storage medium realizes the functions of the above described embodiment, and the program code and the storage medium that stores the program code are included in the scope of the present invention.

Examples of a storage medium for supplying program code include a floppy disk, a hard disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Program code can also be supplied by being downloaded via a network.

The realization of the functions of the above described embodiment by a computer executing read program code is also included in the scope of the present invention. In addition, the realization of the functions of the above described embodiment by actual processing in part or in entirety performed by an operating system (OS) running on a computer in accordance with instructions of the program code is also included in the scope of the present invention.

In addition, the realization of the functions of the above described embodiment by the following processing is also included in the present invention. That is, a case where program code read from a storage medium is written on a memory included in a function expansion board inserted into a computer or a function expansion unit connected to a computer and then actual processing in part or in entirety is performed in accordance with instructions of the program code by, for example, a CPU incorporated in the function expansion unit is also included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-192265 filed Jul. 24, 2007, which is hereby incorporated by reference herein in its entirety.

What is claimed is:

1. An information processing apparatus capable of creating a job execution folder in which a job flow for operating a processing device to process data input into the processing device is set, the information processing apparatus comprising:
a determining unit adapted to refer to capability information that indicates a capability of each of a plurality of processing devices and determine whether a first processing device specified as a registration destination of the created job execution folder by a user is capable of executing the job flow of the created job execution folder;
a searching unit adapted to, when the determining unit determines that the first processing device is not capable of executing the job flow of the created job execution folder, refer to the capability information and search for at least one second processing device for achieving the job flow of the created job execution folder in collaboration with the first processing device;
a collaborative job execution folder creating unit adapted to, when the searching unit finds the second processing device, create a collaborative job execution folder as an alternative to the created job execution folder, the collaborative job execution folder including a first job execution folder for operating the first processing device to execute a first job flow executable by the first processing device and a second job execution folder for operating the second processing device to execute a second job flow executable by the second processing device; and
a registration requesting unit adapted to request the first processing device to register the first job execution folder and request the second processing device to register the second job execution folder.

2. The information processing apparatus according to claim 1, wherein the searching unit is adapted to search for, as the second processing device, a processing device that has a capability for achieving the job flow of the created job execution folder in collaboration with a capability of the first processing device, and
the collaborative job execution folder creating unit is adapted to create, as the first job execution folder, a folder for operating the first processing device to execute the first job flow employing the capability of the first processing device and create, as the second job execution folder, a folder for operating the second processing device to execute the second job flow employing the capability of the second processing device.

3. The information processing apparatus according to claim 1, wherein the collaborative job execution folder creating unit is adapted to, when the searching unit finds a plurality of second processing devices, present a list of the found plurality of second processing devices to the user and make one second processing device selected from the presented list by the user be a processing device with which the first processing device is to collaborate.

4. The information processing apparatus according to claim 1, further comprising:
an inquiring unit adapted to, when the determining unit determines that the first processing device is not capable of executing the job flow of the created job execution folder, inquire of the user whether the job flow of the created job execution folder is to be reedited or the first processing device and the second processing device are to collaborate with each other; and
an editing unit adapted to, when the user replies that the job flow of the created job execution folder is to be reedited in response to the inquiry from the inquiring unit, reedit the job flow of the created job execution folder to form a job flow executable by the specified processing device,
wherein, when the user replies that the first processing device and the second processing device are to collaborate with each other in response to the inquiry from the inquiring unit, the searching unit searches for the second processing device.

5. An information processing method for creating a job execution folder in which a job flow for operating a processing device to process data input into the processing device is set, the information processing method comprising:
referring to capability information that indicates a capability of each of a plurality of processing devices;
determining whether a first processing device specified as a registration destination of the created job execution folder by a user is capable of executing the job flow of the created job execution folder;
referring to the capability information;
searching for at least one second processing device for achieving the job flow of the created job execution folder in collaboration with the first processing device when it is determined that the first processing device is not capable of executing the job flow of the created job execution folder in the determining;
creating a collaborative job execution folder as an alternative to the created job execution folder when the second processing device is found in the searching, the collaborative job execution folder including a first job execution folder for operating the first processing device to execute a first job flow executable by the first processing device and a second job execution folder for operating the second processing device to execute a second job flow executable by the second processing device; and
requesting the first processing device to register the first job execution folder and requesting the second processing device to register the second job execution folder.

6. The information processing method according to claim 5, wherein, in the searching, a processing device that has a capability for achieving the job flow of the created job execution folder in collaboration with a capability of the first processing device is searched for as the second processing device, and
in the creating the collaborative job execution folder, a folder for operating the first processing device to execute the first job flow employing the capability of the first processing device is created as the first job execution folder and a folder for operating the second processing device to execute the second job flow employing the capability of the second processing device is created as the second job execution folder.

7. The information processing method according to claim 5, wherein, in the creating the collaborative job execution folder, when a plurality of second processing devices is found in the searching, a list of the found plurality of second processing devices is presented to the user and one second processing device selected from the presented list by the user is made to be a processing device with which the first processing device is to collaborate.

8. The information processing method according to claim 5, further comprising:
inquiring of the user whether the job flow of the created job execution folder is to be reedited or the first processing device and the second processing device are to collaborate with each other when it is determined that the first processing device is not capable of executing the job flow of the created job execution folder in the determining; and
reediting the job flow of the created job execution folder to form a job flow executable by the specified processing device when the user replies that the job flow of the created job execution folder is to be reedited in response to the inquiring,
wherein, when the user replies that the first processing device and the second processing device are to collaborate with each other in response to the inquiring, the second processing device is searched for in the searching.

9. A storage medium that stores a program for creating a job execution folder in which a job flow for operating a processing device to process data input into the processing device is set such that the program is readable by a computer, the program operating the computer to execute a method comprising:
referring to capability information that indicates a capability of each of a plurality of processing devices;
determining whether a first processing device specified as a registration destination of the created job execution folder by a user is capable of executing the job flow of the created job execution folder;
referring to the capability information;
searching for at least one second processing device for achieving the job flow of the created job execution folder in collaboration with the first processing device when it is determined that the first processing device is not capable of executing the job flow of the created job execution folder in the determining;
creating a collaborative job execution folder as an alternative to the created job execution folder when the second processing device is found in the searching, the collaborative job execution folder including a first job execution folder for operating the first processing device to execute a first job flow executable by the first processing device and a second job execution folder for operating the second processing device to execute a second job flow executable by the second processing device; and
requesting the first processing device to register the first job execution folder and requesting the second processing device to register the second job execution folder.
